(19) United States
(12) Patent Application Publication
(10) Pub. No.: US 2011/0140324 A1
(43) Pub. Date: Jun. 16, 2011

(54) Damping device having a spring device and a telescopic device

(76) Inventor: Thomas Naber, Ahaus (DE)

(21) Appl. No.: 12/736,354

(22) PCT Filed: Apr. 8, 2009
(86) PCT No.: PCT/EP2009/002592

§ 371 Date: Dec. 14, 2010

(30) Foreign Application Priority Data
Apr. 8, 2008 (DE) 10-2008-017-705.9

(51) Int. Cl. F16F 9/32; F16F 7/00; F16F 9/56

(52) U.S. Cl. 267/140.13; 267/136

(57) ABSTRACT

A damping device having a spring device and a telescopic device which is coupled to the spring device. The telescopic device has a plurality of telescopic elements which are coupled together in such a way that a predetermined damping force is generated when the telescopic elements are displaced relative to each other.

### FIELD OF THE INVENTION

The present invention relates to a damping device that is suitable for use in vehicles having an automatic level control system.

### BACKGROUND INFORMATION

Vehicles with air suspension often have need of adjusting the air suspension in a wide range of levels. For example, a need for minimum/maximum ratios of 1/3 is not rare. Thus for example a minimum level of 200 mm and a maximum level of 600 mm. Reasons for this may be found for example in the need to adapt to loading docks to load and unload commercial vehicles, or in the desire for flexibility in combining a tractor and trailer. The problem is to find suitable elements, such as for example springs or dampers, which are able to cover this wide range of possible levels while retaining full functionality.

The problem is normally solved today using two different concepts, which will be described below.

The first concept is based on the principle of length modification through elastomeric roll-up. An elastomeric bellows is employed, whose design makes it suitable for the required stroke or travel. FIG. 5 shows such a bellows 502. Bellows 502 may be designed as an air bellows, and may have a bottom 571, a bellows top 572, a bellows piston 573 and a bellows elastic 574. If a pressure is exerted on bottom 571 or bellows top 572, a distance between bottom 571 and bellows top 572 may be reduced. As that happens, bellows elastic 574 may form a rolling fold, which may shift in the direction of bottom 571 under increasing pressure.

The disadvantage of the first concept is that a large installation space is necessary to support a certain load at a certain pressure. Another disadvantage is that the design creates soft spring characteristics, which are poorly suited for damping. Furthermore, bellows 502 is only suited for absorbing pressure forces, not for absorbing tensile forces.

The second concept is based on the principle of the modified lever arm. This principle is frequently used in shock absorbers. Since it is not practical for a damper to execute the required long strokes or travel distances, the suspension position and the linkage points of the damper are modified, so that a lever transmission results. The disadvantage of this design is the often unfavorable position of the damper installation, which is needed in many cases for other components, and the greater force required. To compensate for the greater force, it is necessary to increase the diameter of the damper. Furthermore, the fine adjustability and the response behavior of these designs deteriorate.

### SUMMARY OF THE INVENTION

An object of the exemplary embodiments and/or exemplary methods of the present invention is to create an improved damping device.

This object is achieved by a damping device as described herein.

The exemplary embodiments and/or exemplary methods of the present invention are based on the finding that telescopable elements may be employed advantageously for a suspension or damping. It is possible, using the telescopable elements, to expand a working range within which the damping device according to the exemplary embodiments and/or exemplary methods of the present invention may be utilized. The working range is definable by a minimum and a maximum distance between two elements to be damped, within which the damping device has a specified damping or suspension characteristic.

The exemplary embodiments and/or exemplary methods of the present invention create a damping device having the following features: a spring device, and a telescopic device that is coupled to the spring device, the telescopic device having a plurality of telescopic elements which are coupled together in such a way that when the telescopic elements are displaced relative to each other a predetermined damping force is generated.

Advantageously, the damping device according to the present invention may be accommodated in a small installation space.

Harder spring characteristics may also be implemented, and both pressure forces and tensile forces may be absorbed. In addition, the damping device has good fine adjustability and good response behavior.

Exemplary embodiments of the present invention are explained in greater detail below with reference to the accompanying drawing.

### BRIEF DESCRIPTION OF THE DRAWINGS

FIG. 1 shows a schematic representation of a damping device according to the present invention.

FIG. 2 shows a representation of a damping device according to the present invention having a bellows.

FIG. 3 shows a representation of another damping device according to the present invention.

FIG. 4 shows a representation of another damping device according to the present invention.

FIG. 5 shows a bellows according to the existing art.

### DETAILED DESCRIPTION

In the following description of the exemplary embodiments of the present invention, the same or similar reference numerals are used for the similarly working elements shown in the various drawings, while omitting a repeated description of these elements.

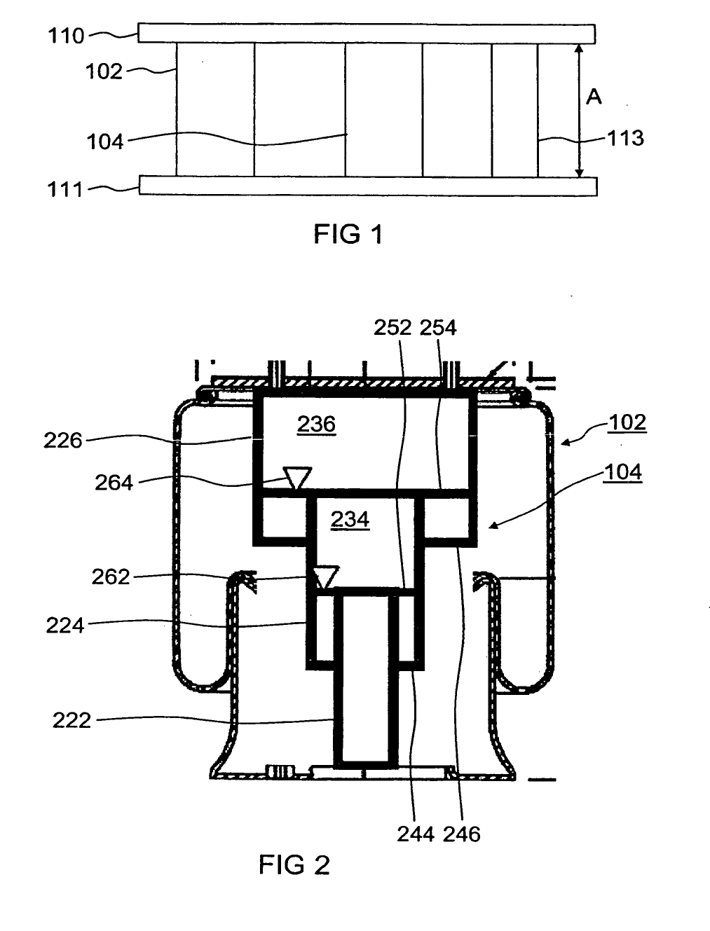

FIG. 1 shows a schematic representation of a damping device according to one exemplary embodiment of the present invention. The damping device has a spring device 102 and a telescopic device 104. The damping device is situated between a first element 110 and a second element 111, and may be designed to damp or absorb vibrations and/or impacts between elements 110, 111. To that end, spring device 102 and telescopic device 104 may be connected to first element 110 and second element 111, and thus be joined together.

A distance A for elements 110, 111 at rest may be adjustable between a smallest distance and a largest distance. Distance A may be set using an adjusting device 113. The damping device may be designed for adapting its extension between elements 110, 111 to distance A. In particular, the damping device may be designed to have a predetermined damping characteristic or spring characteristic at both the smallest distance and the largest distance, as well as at all distances in between. To that end, telescopic device 104 has a plurality of telescopic elements (shown in FIG. 2).

As shown in FIG. 1, spring device 102 and telescopic device 104 may be implemented as separate subassemblies and may be situated at a distance from each other. Alternatively, spring device 102 and telescopic device 104 may be designed as a combined subassembly. For example, either spring device 102 or telescopic device 104 may be integrated into the other subassembly. The damping device according to the present invention may also have a combination of a plurality of spring devices 102 and/or telescopic devices 104.

FIG. 2 shows a damping device according to another exemplary embodiment of the present invention. The damping device has a spring device 102 and a telescopic device 104. Telescopic device 104 is situated inside of spring device 102.

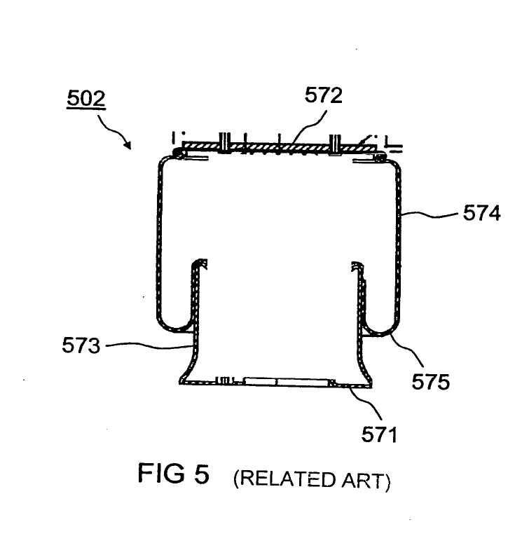

Spring device 102 is formed as an air suspension. For example, spring device 102 may be an air bellows having the features described on the basis of FIG. 5.

According to this exemplary embodiment, telescopic device 104 has a first telescopic element 222, a second telescopic element 224 and a third telescopic element 226. First telescopic element 222 may be fixedly connected to the bottom and third telescopic element 226 may be fixedly connected to the bellows top of bellows 502. Second telescopic element 224 may be situated as a floating telescopic element between first telescopic element 222 and third telescopic element 226.

Telescopic elements 222, 224, 226 may be coupled together in such a way that when the telescopic elements are displaced relative to each other a predetermined damping force is generated. The predetermined damping force may be used to set a harder spring characteristic of the damping device. The predetermined damping force may be dependent of a speed with which telescopic elements 222, 224, 226 are displaced relative to each other. In order to have a better damping or spring characteristic, telescopic elements 222, 224, 226 may be designed in such a way that the predetermined damping force increases at a higher speed. Furthermore, telescopic elements 222, 224, 226 may be shaped in such a way that the predetermined damping force is generated when telescopic elements 222, 224, 226 are pulled apart and/or pushed together. If the damping force is generated both when pressing together and when pushing apart, the damping device is able to absorb and damp both pressure and tensile forces. To coordinate the movement sequence, the diameters and lengths of the telescopic elements may be matched to each other in a certain way, and may be supported if appropriate by additional elements such as springs or magnetic influencing elements.

According to this exemplary embodiment, first telescopic element 222 has a smaller diameter than second telescopic element 224 and second telescopic element 224 has a smaller diameter than third telescopic element 226. In this way, telescopic elements 222, 224, 226 are able to form a first compression space 234 and a second compression space 236. Compression spaces 234, 236 each have two chambers. When telescopic elements 222, 224, 226 are pulled apart or pushed together, a fluid present in compression spaces 234, 236, for example air, is exchanged between the chambers. A resulting flow resistance may result in the predetermined damping force.

In order to form compression spaces 234, 236, telescopic elements 222, 224, 226 have outer sealing elements 244, 246 and inner sealing elements 252, 254. The second telescopic element has a first outer sealing element 244. First outer sealing element 244 is situated in such a way that it seals off one end of second telescopic element 224, which surrounds first telescopic element 222, from first telescopic element 222. Correspondingly, third telescopic element 226 has a second outer sealing element 246. Second outer sealing element 246 is situated in such a way that it seals off an end of third telescopic element 226, which surrounds second telescopic element 224, from second telescopic element 224.

Furthermore, first telescopic element 222 has a first inner sealing element 252. First inner sealing element 252 is situated in such a way that it seals off an end of first telescopic element 222, which is located inside of second telescopic element 224, from second telescopic element 224. Correspondingly, second telescopic element 224 has a second inner sealing element 254. Second inner sealing element 254 is situated in such a way that it seals off an end of second telescopic element 224, which is located inside of third telescopic element 226, from third telescopic element 226.

Thus first compression space 234 is subdivided by first inner sealing element 252 into two chambers, which are connected via an opening 262 in first inner sealing element 252. Corresponding thereto, second compression space 236 is subdivided by second inner sealing element 254 into two chambers, which are connected via an opening 264 in second inner sealing element 254. During an upward deflection of the damping device, the chambers situated beneath inner sealing elements 252, 254 in FIG. 2 function as compression space. During a compression of the damping device, the chambers situated above inner sealing elements 252, 254 function as compression space. Openings 262, 264 may be designed as damping reactors.

If distance A shown in FIG. 1 changes, then the distance between the bottom and the bellows top of the bellows shown in FIG. 2 changes. A ratio between the smallest and largest adjustable value for distance A may be dependent on the number of telescopic elements 222, 224, 226. The number and length of telescopic elements 222, 224, 226 may be chosen corresponding to the intended smallest and largest distance value and the ratio resulting therefrom.

This invention is thus based on the idea that the minimum/maximum ratio may be improved by using a telescope-like cylinder 104 in a bellows 502 or in proximity to a bellows.

The telescope-like cylinder may be made up of at least three telescopic elements 222, 224, 226, and in the version having three telescopic elements 222, 224, 226 it may ideally fulfill a minimum/maximum ratio of 1/3.

More than three telescopic elements 222, 224, 226 are also possible. As a result, it is possible to achieve ideal ratios of 1/4, 1/5 and in general 1/[number of telescopic elements]. Furthermore, the cylinder may be designed in such a way that both pressure and tensile forces may be absorbed. That makes it possible to improve the integrated suitability as a damping element substantially.

The exemplary-embodiment shown in FIG. 2 may constitute an integrated air spring damper for a commercial vehicle. The unit shown is made up of a conventional bellows 502 having a hollow, air-tight bellows piston and a three-part telescopic cylinder 104, which is attached at one end to the bellows top and at the other end to the bellows piston bottom. The middle part 224 of telescopic cylinder 104 is “float”-supported between the two attached parts 222, 226. The diameters of telescopic cylinder parts 222, 224, 226 are significantly different, so that even during upward deflection a compression space 234, 236 results which improves the damping performance.

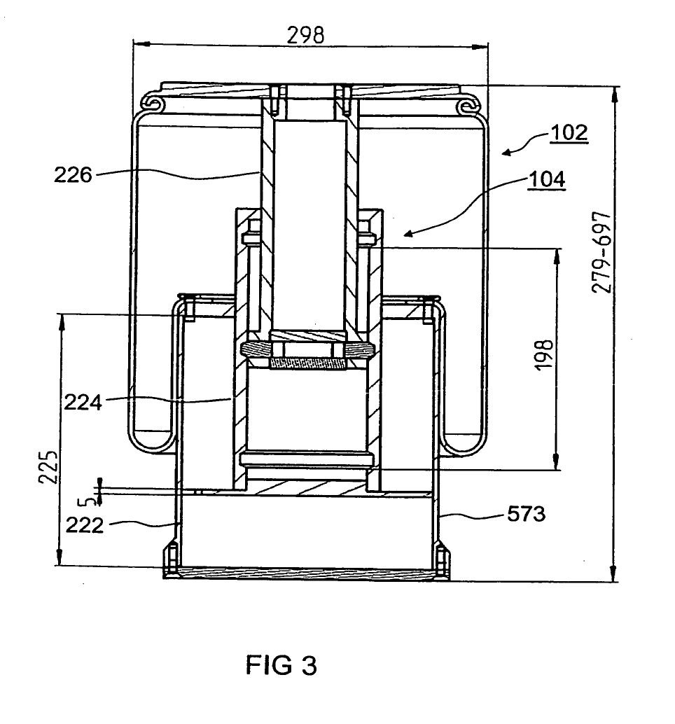

FIG. 3 shows a damping device according to another exemplary embodiment of the present invention. The damping device has a spring device 102, for example in the form of the bellows described on the basis of FIG. 5, and a telescopic device 104. In contrast to the exemplary embodiment shown in FIG. 2, the bellows piston has a damper piston rod 222 which is telescopable. Damper piston rod 222 thus forms the first telescopic element of telescopic device 104. According to this exemplary embodiment, first telescopic element 222 has a smaller diameter than second telescopic element 224 and second telescopic element 224 has a smaller diameter than third telescopic element 226.

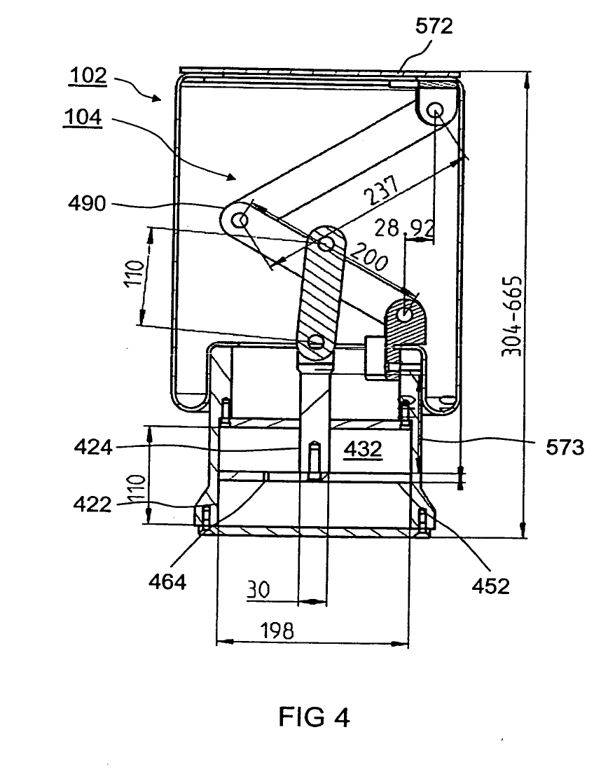

FIG. 4 shows a damping device according to another exemplary embodiment of the present invention. The damping device has a spring device 102, for example in the form of the bellows described on the basis of FIG. 5, and a telescopic device 104. In contrast to the exemplary embodiment described in FIG. 2, the large minimum/maximum ratio is producible via an internal lever transmission.

Telescopic device 104 has a first telescopic element 422 and a second telescopic element 424. First telescopic element 422 is assigned to bellows piston 573, and forms a compression space 432. Second telescopic element 424 has an inner sealing element 452, which seals off an end of second telescopic element 424, which is located inside of first telescopic element 422, from first telescopic element 422. Inner sealing element 452 has an opening 464, through which a fluid present in compression space 432 may flow when second telescopic element 424 moves.

Telescopic device 104 also has a lever device 490, via which second telescopic element 424 is coupled with bellows top 572 and bellows piston 573, so that a movement of bellows top 572 may be transmitted to second telescopic element 424. The lever device may have three lever elements. According to this exemplary embodiment, a first lever element and a second lever element are movably connected to bellows top 572 and to bellows piston 573, respectively. In addition, the first and second lever elements are movably connected. A third lever element is movably connected to the second lever element and to second telescopic element 424.

The movement sequence of the telescopic elements shown in the exemplary embodiments may be established by additional springs or magnetic elements.

The damping device according to the present invention is not limited to the exemplary embodiments shown. In particular, the described exemplary embodiments may also be combined with each other. Instead of the bellows, a different suitable spring and/or damping mechanism may be utilized, and the arrangement of the telescopic device may be varied. Furthermore, the damping device may have a plurality of spring devices and/or damping mechanisms. The sealing elements may also have a plurality of openings or damping reactors. In addition to damping a vehicle body having an automatic level control system, the damping device is suitable in general for vibration damping and/or shock absorption in any elements whose distance from each other is adjustable. Where dimensions are indicated in the figures, these are chosen only to serve as examples.

### THE LIST OF REFERENCE NUMERALS IS AS FOLLOWS

102 spring device
104 telescopic device
110, 111 element
113 adjusting device
222, 224, 226 telescopic elements
234, 236 compression spaces
244, 246, 252, 254 sealing elements
262, 264 openings
422; 424 telescopic elements
432 compression space
452 sealing element
464 opening
490 lever device
502 bellows
571 bottom
572 bellows top
573 bellows piston
574 bellows elastic

1-16. (canceled)

17. A damping device, comprising:
a spring device; and
a telescopic device, which is coupled to the spring device, the telescopic device having a plurality of telescopic elements, which are coupled together so that a predetermined damping force is generated when the telescopic elements are displaced relative to each other.

18. The damping device of claim 17, wherein the predetermined damping force is dependent on a speed with which the telescopic elements are displaced relative to each other, and wherein the predetermined damping force is greater at a higher speed than at a lower speed.

19. The damping device of claim 17, wherein the predetermined damping force is generated when the telescopic elements are at least one of pulled apart and pressed together.

20. The damping device of claim 17, wherein the telescopic device is situated inside the spring device.

21. The damping device of claim 17, wherein the spring device is configured as a bellows.

22. The damping device of claim 17, wherein the telescopic elements are arranged so that they form at least one compression space provided with an opening, where a volume of the compression space changes due to the telescopic elements being displaced relative to each other, and wherein the damping force is dependent on a flow resistance of a fluid flowing through the opening.

23. The damping device of claim 22, wherein the telescopic device has a first telescopic element, at least one second telescopic element and a third telescopic element, and wherein the at least one second telescopic element is situated between the first telescopic element and the third telescopic element, and ends of the telescopic elements which overlap each other having sealing elements to form a plurality of compression spaces.

24. The damping device of claim 23, wherein the first telescopic element has a smaller diameter than the second telescopic element, wherein the first telescopic element has a first inner sealing element which seals off an end of the first telescopic element which is located inside the second telescopic element from the second telescopic element, and wherein the second telescopic element has a first outer sealing element which seals off an end of the second telescopic element which surrounds the first telescopic element from the first telescopic element.

25. The damping device of claim 23, wherein the second telescopic element has a smaller diameter than the third telescopic element, wherein the second telescopic element has a second inner sealing element which seals off an end of the second telescopic element which is located inside the third telescopic element from the third telescopic element, and wherein the third telescopic element has a second outer sealing element which seals off an end of the third telescopic element which surrounds the second telescopic element from the second telescopic element.

26. The damping device of claim 24, wherein the inner sealing element has at least one opening.

27. The damping device of claim 17, wherein the damping device is situated between two elements which are spaced at a distance from each other, wherein a distance between the two elements is adjustable at least to a smallest and a largest distance value, and wherein the damping device is configured to cause a damping between the two elements.

28. The damping device of claim 27, wherein the damping device has an adjusting device which is configured to adjust the distance between the two elements at least to the smallest and the largest distance value.

29. The damping device of claim 27, wherein a ratio between the smallest distance value and the largest distance value is dependent on the number of telescopic elements of the telescopic device.

30. The damping device of claim 17, wherein a movement sequence of the telescopic elements is established by at least one of additional springs and magnetic elements.

31. The damping device of claim 17, further comprising:
a damper piston rod, which is telescopable.

32. The damping device of claim 17, wherein the telescopic device has a lever device.
